(19) United States
(12) Patent Application Publication
(10) Pub. No.: US 2005/0082116 A1
(43) Pub. Date: Apr. 21, 2005

(54) Rescue system for high-rise buildings

(76) Inventor: Eliyahu Nir, Pardesiya (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/503,737

(22) PCT Filed: Jan. 3, 2003
(86) PCT No.: PCT/IL03/00072

(30) Foreign Application Priority Data
Feb. 4, 2002 (IL) 147975

(51) Int. Cl. B65G 15/00; B66B 9/08; A62B 1/20

(52) U.S. Cl. 182/48; 182/43

(57) ABSTRACT

A system for the evacuation of individuals from a first, elevated level to a second, lower level by gliding down a rescue sleeve. The system comprises a sleeve (22) made of cloth or the like material having an entrance end located at the first level and an exit end located at the second level. A series of equidistanced rigid reinforcing rings (24) embrace the sleeve (22). Elongated spacers (28) are provided, fastened at one end thereof to one of the rings (24) and at their other end to a centrally extending cable (26). One end of the sleeve (22) is rotated relative to the other end about the cable (26) so that the sleeve becomes coiled around it at a distance defined by the elongated spacers (28).

### BACKGROUND OF THE INVENTION

The present invention relates to rescue systems for evacuating individuals trapped in high rise buildings in case of emergency situations such as fire or earthquake.

The invention particularly concerns rescue systems of the kind disclosed in the inventor's International Patent Application, published Aug. 30, 2001, as WO 01/62138 (herein referred to “the WO Patent”).

As described and claimed in the WO Patent, a system is provided for the evacuation of individuals trapped in multiple story buildings by gliding down a rescue sleeve. The sleeve is composed of sections, each section being made of a sheet material reinforced by a circumferential rigid support member, and the sections are connected to each other to form a continuous envelope. At least a pair of cables is provided, threaded along the sleeve, one at the bottom and one at the top generatrix thereof. A pair of winch systems are provided for winding the cables into a dedicated location at the building story from which rescue is to be initiated, so that the sleeve becomes folded into a compact package. Coil springs are used for selectively ejecting and unfolding the sleeve down to ground level where it is anchored to a stationary object.

Thus, the rescue sleeve of the WO Patent is designed to unfold and deploy in an inclined direction, from the evacuation point down to the ground level. This feature presents a certain disadvantage in that the anchoring point of the lower end of the sleeve has to be placed at a distance from the building, depending on the height of the story designated as the evacuation point. This operational pre-requisite may not always be satisfied, depending on the urban surrounding of the building in question.

In order to cure this deficiency, the present inventor has developed an alternative arrangement (c.f. Israel Patent Application No. 145935 filed Oct. 15, 2001) wherein a vertically spiraling sleeve has replaced the inclined rescue sleeve configuration.

Although the spiral sleeve concept and principles of construction adequately solved the above mentioned problem, certain aspects thereof needed refinement. Hence, as a result of further engineering research and development the present invention has been conceived.

### SUMMARY OF THE INVENTION

A system for the evacuation of individuals from a first, elevated level to a second, lower level by gliding down a rescue sleeve, the system comprising a sleeve made of cloth or the like material having an entrance end located at the first level and an exit end located at the second level; a series of equidistanced rigid reinforcing rings embracing the sleeve; means for deploying the sleeve vertically from the first level to the second level; an extendible axle member; means for stretching the axle member from the first level to the second level in parallel to and distanced from the sleeve; a series of elongated spacers, each fastened at one end thereof to one of the said rings and rotatably connected at its opposite end to the axle member; and means for rotating one end of the sleeve relative to the other end about the axle member so that the sleeve becomes coiled around the axle member at a distance defined by the elongated spacers.

According to another aspect of the invention there is provided a method of forming a coiled sleeve for the rescue by gliding therethrough of individuals from a first, elevated level to a second, lower level, comprising the steps of: suspending the sleeve between a first support located at the first level and a second support located at the second level; providing an extendible axle member between the first and the second supports, distanced from and parallel to the sleeve; providing distancing means between the sleeve and the axle member; and rotating one end of the sleeve relative to the other end thereof about the axle member.

### BRIEF DESCRIPTION OF THE DRAWINGS

These and further constructional features and advantages of the invention will be more clearly understood in the light of the ensuing description of two preferred embodiments thereof, given by way of example only, with reference to the accompanying drawings, wherein

FIG. 1 is a general perspective view of the system in the final operative position thereof;

FIG. 2 is a sectional side-view schematically showing the main components of the system in the folded, standby position;

FIG. 3 is a view taken along line III-III of FIG. 2;

FIG. 4 illustrates the stage of starting the unfolding of the sleeve;

FIGS. 5a and 5b are details of construction of the spoke-like cross-rods;

FIG. 6 shows a detail of construction relating to a central axle member around which the sleeve will be rotated in order to assume its final, coiled configuration;

FIG. 7 illustrates the system in the fully, vertically unfolded sleeve state;

FIG. 7a is a detail of FIG. 7 on an enlarged scale;

FIG. 8 demonstrates the initiation of the convoluting process of the sleeve;

FIG. 9 shows the system in the fully coiled, ready for use position of the sleeve;

FIG. 10 is a view taken along line X-X of FIG. 9;

FIG. 11 is a sectional side-view of a system proposed according to a modified embodiment of the present invention;

FIG. 12 is a view taken along line XII-XII of FIG. 11;

FIG. 13 shows the bottom portion of the modified system in more detail;

FIG. 14 is a view taken along line XIV-XIV of FIG. 13; and

FIG. 15 is a further modified version of the embodiment of FIGS. 11-14.

### DETAILED DESCRIPTION OF PREFERRED EMBODIMENTS

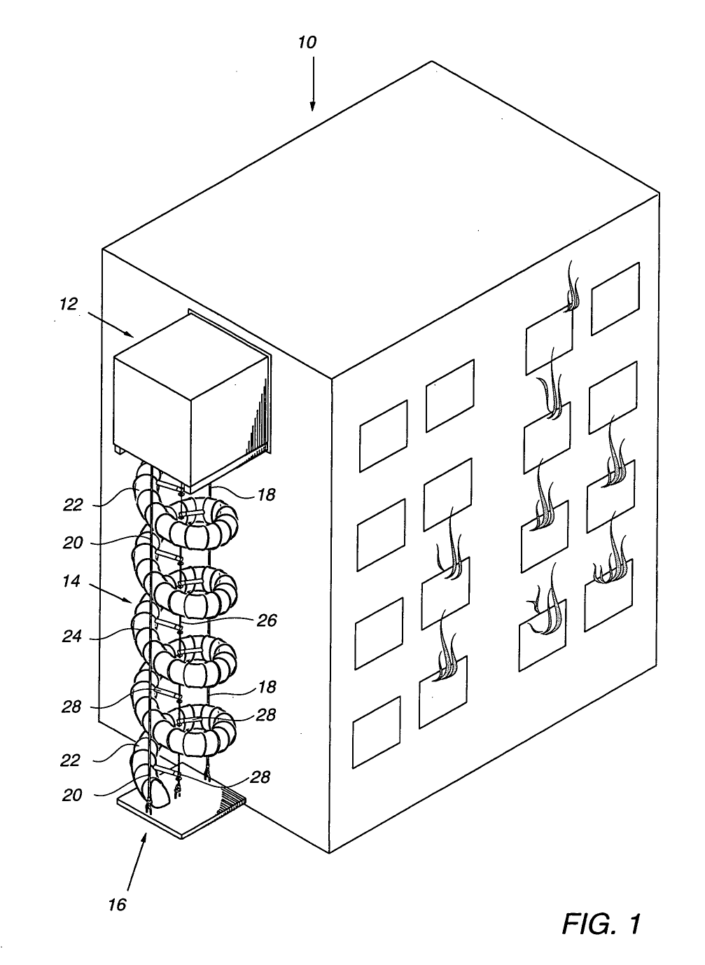

As seen in FIG. 1, building 10 is on fire or under other disastrous situation calling for quick mass evacuation.

A retractable storage compartment 12, housing a rescue system, has been withdrawn from one of the elevated stories. The rescue system, presented in its final, operative position, comprises a rescue sleeve assembly 14 coiling down from the floor of the compartment 12 to a base plate 16 that has been lowered by cables 18 and 20 to the ground level (or to a lower story of the building, as determined by the operating rescue team).

The sleeve denoted 22 is made of canvas, preferably fireproof, reinforced by numerous rings 24 attached uniformly around the sleeve all along, at an equal distance one from the other for a reason that will be explained below. Although the rings 24 are shown as discrete components, it should be noted that instead of a continuous coil of flexible wire, e.g. of steel, may equally be employed, and the term “rings” as herein used is intended to include such modification.

It will be further noted that a cable 26 extends along the geometrical axis of the coiled sleeve, tied between the floor of the compartment 12 and the center of the base plate 16, and that a plurality of elongated spacers, preferably in the form of spoke-like rods or sticks 28, are connected between the central cable 26 and all or some of the reinforcing rings 24, at fixed intervals (say, every second or third ring is so connected).

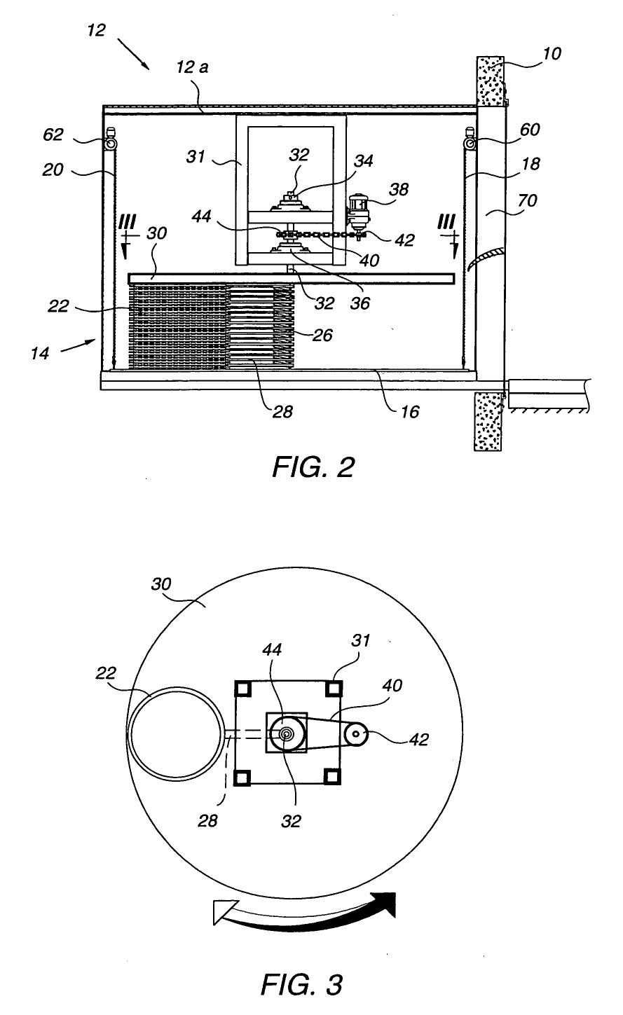

In the standby position of the system shown in FIG. 2, the sleeve 22 is folded-down, namely all the rings 24 are vertically stacked on the base plate 16, one on top of the other, with the canvas or other sheet material freely folded between the respective rings.

The upper, open end of the sleeve 22 is attached to a revolving turntable in the form of a circular plate 30. The plate 30 is suspended from a structure 31 anchored to ceiling 12a of the retractable storage compartment 12.

The structure 31 rotatably supports shaft 32 by a thrust bearing 34 and plain bearing 36. Rotation of the plate 30 is attained by electric motor 38 coupled to the shaft 32 by transmission belt or chain 40 and pulleys or sprocked wheels 42 and 44.

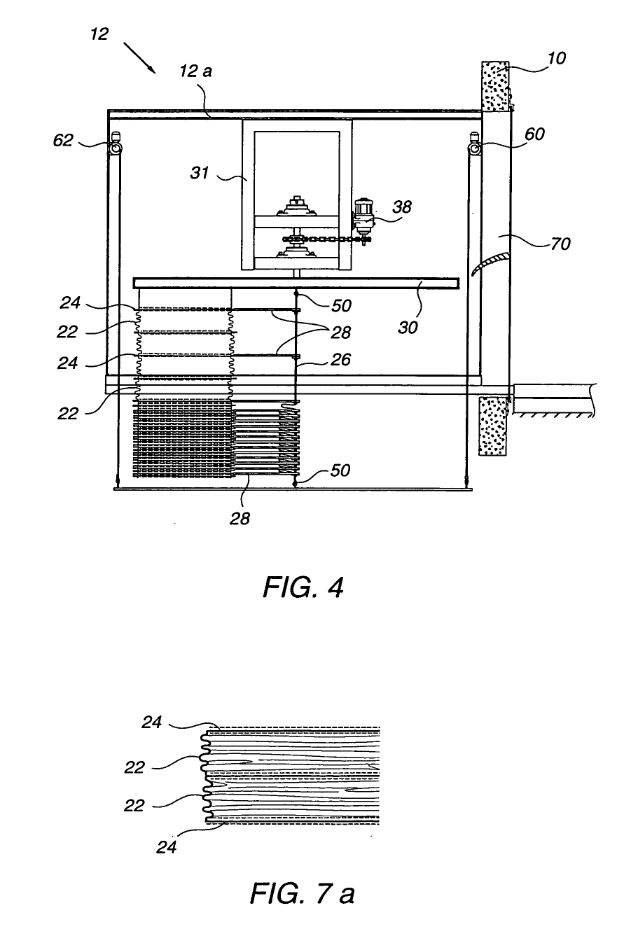

As better seen in FIG. 4, the central cable 26 is connected to the center of the plate 30, e.g. by swivable bracket 50 (to avoid becoming twisted as will be understood from the following description).

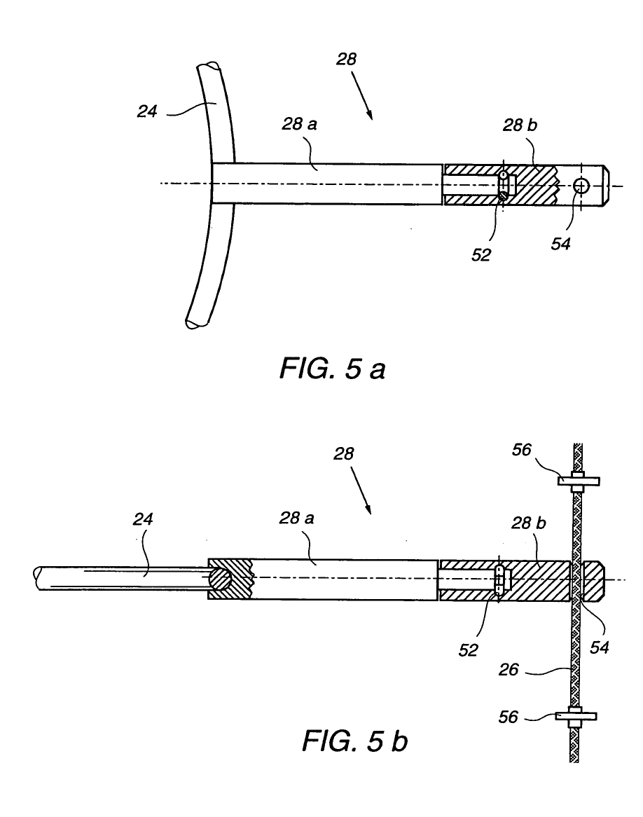

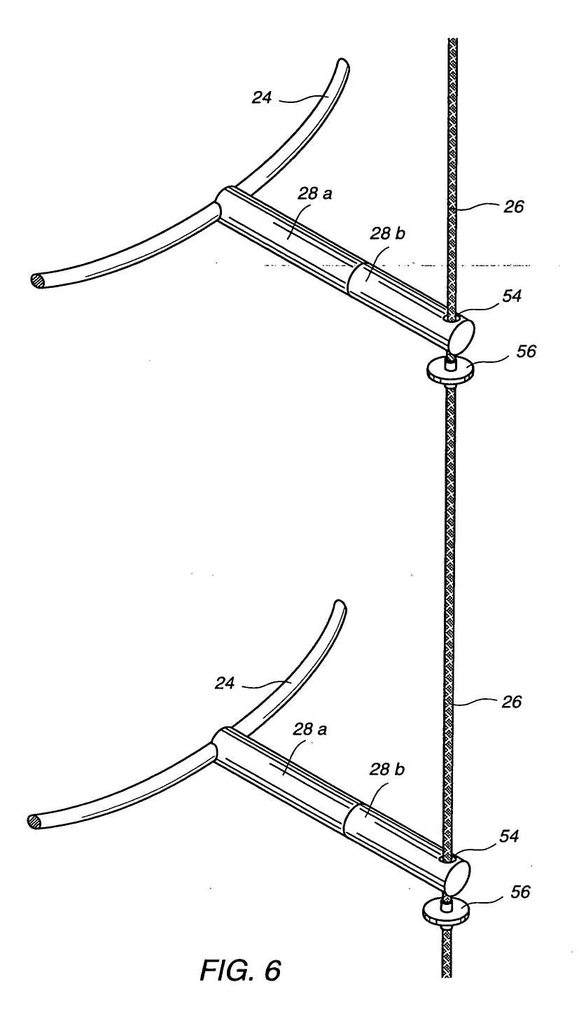

The central cable 26 is connected to the rings 24 of the sleeve 22 in the following manner. The spoke-like rods 28 are preferably composed of two sections (see FIGS. 5a, 5b and 6): one, 28a, is rigidly mounted to its respective sleeve ring 24; and the other, 28b, is rotatably coupled to the section 28a, e.g. by a split-ring connection 52, so that one is freely rotatable with respect to the other. The free end of the section 28b is formed with an opening 54 through which the cable 26 is freely passed, as clearly seen in FIG. 6. A complementary series of distance-keeping discs 56 are beaded along and firmly attached to the cable 26, at pre-fixed distances determined according to a parameter to be explained further below.

It will now be better understood that in the standby position of FIG. 2, the cable 26, along with the discs 56, is loosely piled up, with the spokes 28 lying more-or-less in the same, vertical plane.

Finally, shown in FIG. 2 are a pair of winch devices 60 and 62 for lowering (and raising) the base plate 16.

The manner of erecting the sleeve 22 into the coiled configuration as requested for the operation thereof as a rescue sleeve will be now described.

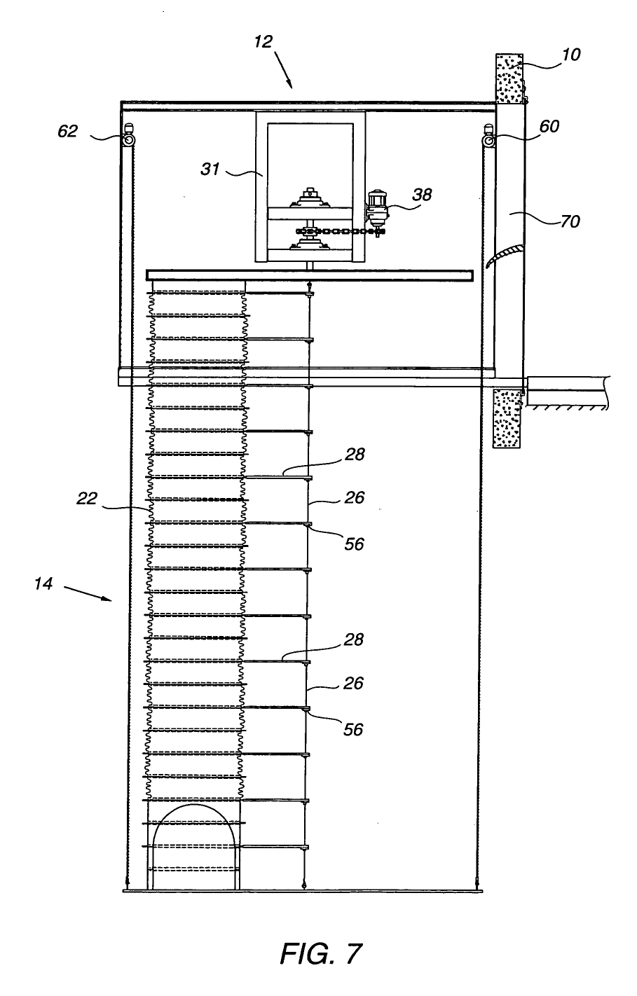

As the plate 16 is lowered, a progressive, gravity activated, process of unfolding the sleeve 22 and the cable 26 takes place—see FIGS. 4 and 7. The process is interrupted when the plate 16 reaches the required lower level. The lengths of the canvas sections between adjacent rings 24 are so designed that at the target position, the canvas is NOT stretched to its full length but on the contrary—it must remain loose to a certain extent (see crimping lines in FIG. 7a) in order to enable the further phase of converting the vertical, linear position of the sleeve into the spiral configuration. Note that in this position, all the spokes 28 assume a horizontal orientation.

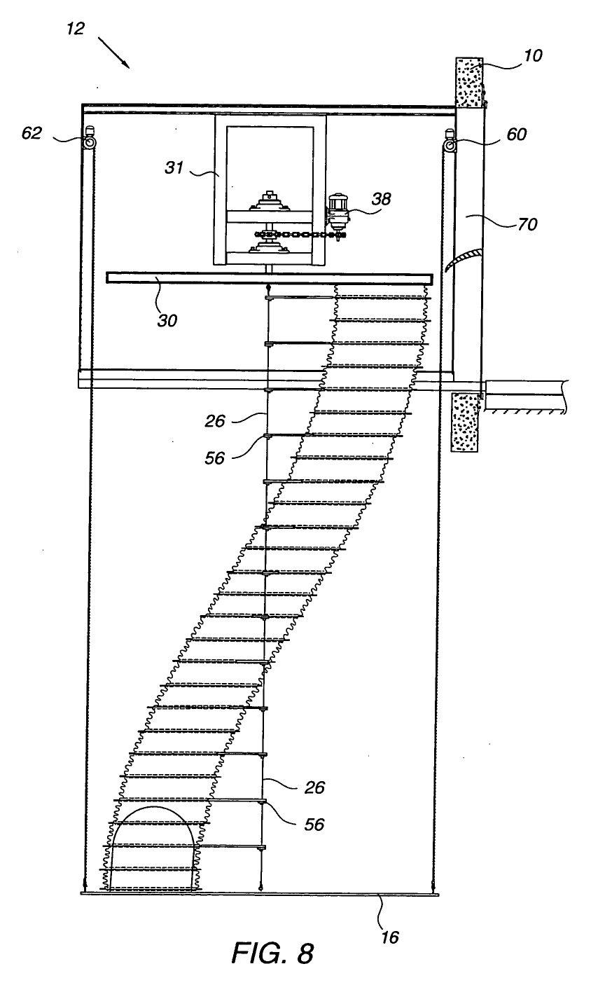

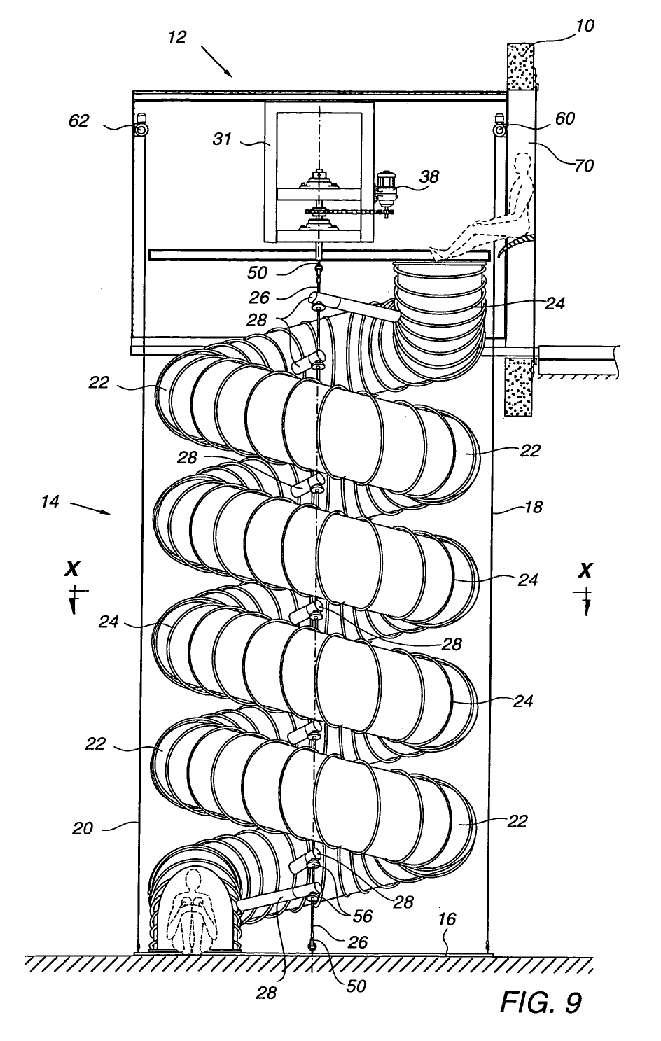

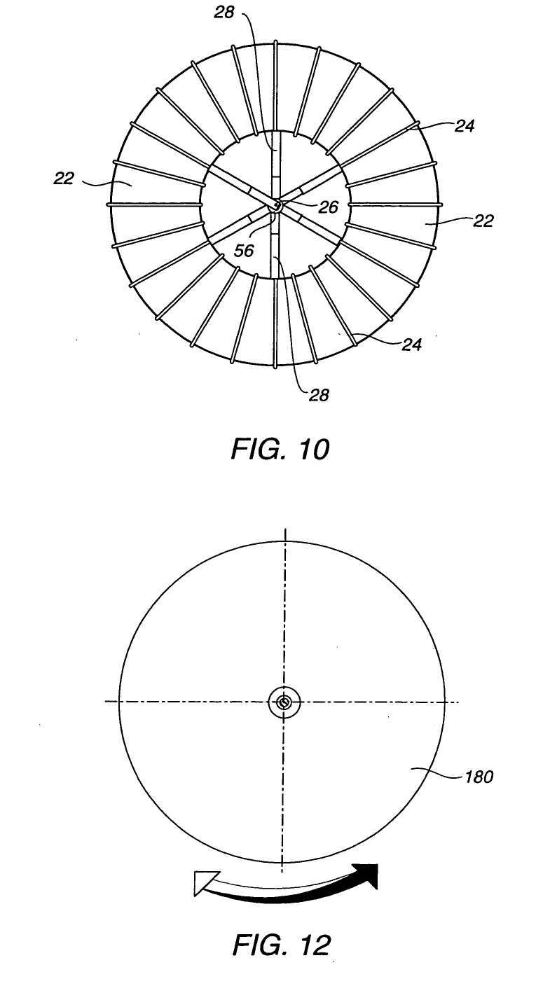

The coiling of the sleeve is attained by starting the motor 38 to rotate the plate 30, while the lower end of the sleeve remains affixed to the base plate 16 which remains stationary. As a result (see FIG. 8), the sleeve as a whole starts to wind around the central cable 26. The plate 30 continues to revolve in the same selected direction (clockwise in the exemplified embodiment) so that, gradually, a multiple-convolution spiral is attained as vividly shown in FIG. 9. The spokes 28, while kept more-or-less horizontal, must allow a limited rotational movement of the rings 24 (by up to 90°); this condition is satisfied by the provision of the swivel coupling 52.

The rotation of the plate 30 will be stopped after formation of an adequate number of convolutions has been developed for safe gliding (4½ in the example of FIG. 9), and the opening of the sleeve 22 is located adjacent to building exit 70 through which the survivors access the rescue system 14 as shown in phantom lines.

Converting the system 14 back into the stored, standby position (FIG. 2) is achieved by reversing the order of stages as previously described: Turning the plate 30 in the counter-clockwise direction by 41/₂ revolutions, and then lifting the base plate 16 along with the axial cable 26 and cross-rods 28 back into the storage compartment 12.

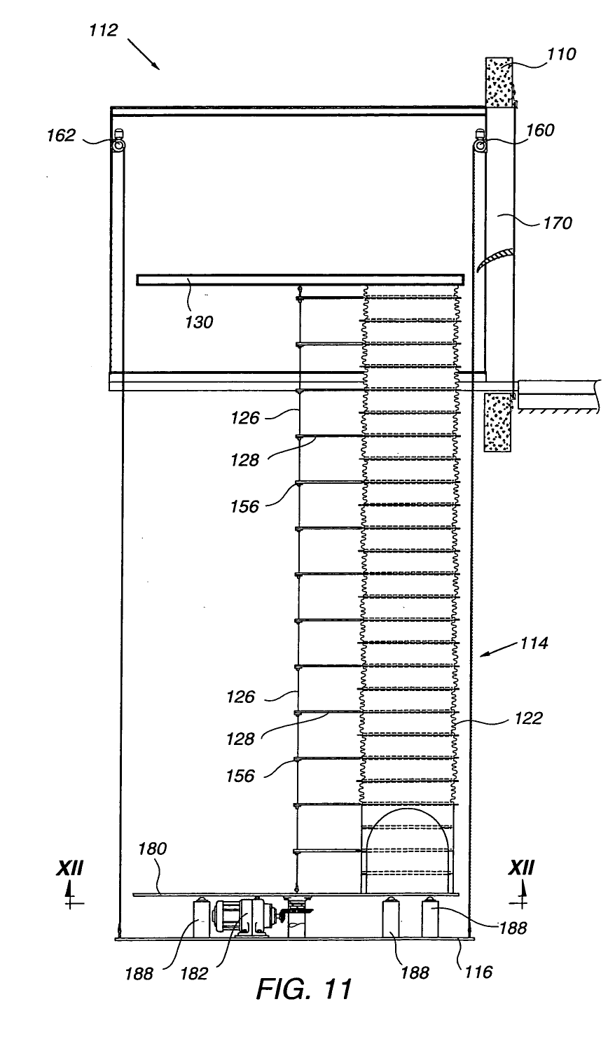

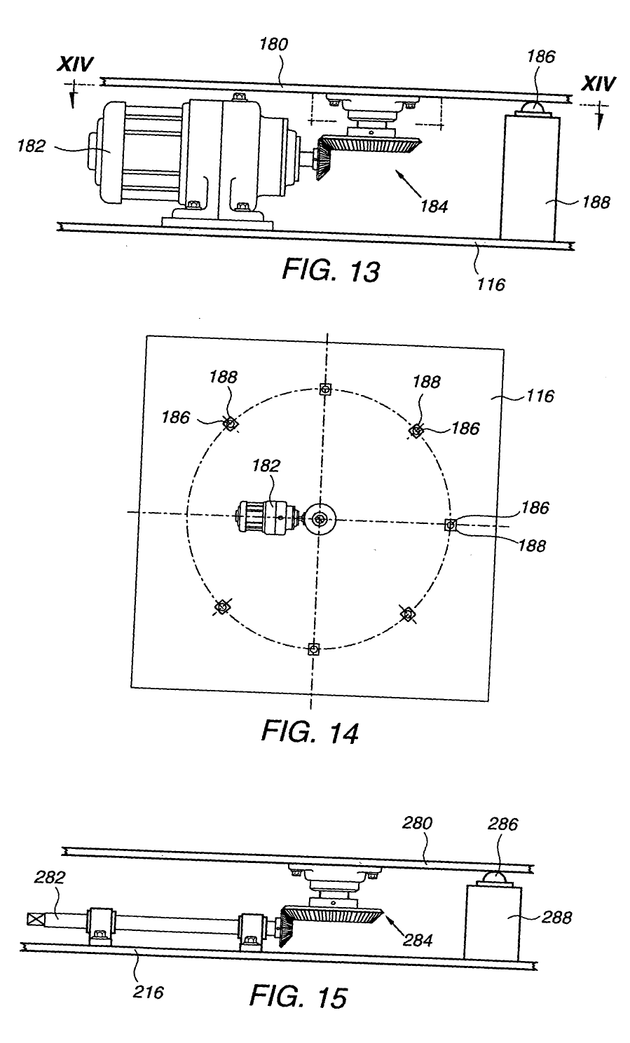

According to a second, modified embodiment of the present invention described in conjunction with FIGS. 11-15 the winding of the sleeve 122 is perfected by a rotational movement of the bottom end thereof, rather than the top end.

Hence, the plate 130 is stationary, but in addition to the base plate 116 there is provided a turntable plate 180, rotatable by electric motor 182 intermediate a suitable gear transmission 184. For more stability and durability, the plate 180 is adapted to roll on a series of rolling supports 186 placed on poles 188 along a circular line. The construction and operation of the sleeve system 114 is otherwise analogous to that of the preceding embodiment, namely that formation of the sleeve windings is attained by rotating the plate 180 a suitable number of times until the required gradient of convolutions has been reached for the safe gliding of the rescued people.

According to the modification depicted in FIG. 15, a manually operable drive shaft 282 is provided in addition to or in substitution of the motor 182. This will enable operation of the rescue system in the case of electricity breakdown due to the prevailing disastrous conditions which has initially caused the need to use the emergency rescue sleeve system.

The presently disclosed embodiments are to be considered in all respects as illustrative and not restrictive, the scope of the invention being indicated by the appended claims, rather than the foregoing description, and all changes which come within the meaning and range of equivalency of the claims are therefore intended to be embraced therein.

1. A system for the evacuation of individuals from a first, elevated level to a second, lower level by gliding down a rescue sleeve, the system comprising:
a sleeve made of cloth or the like material having an entrance end located at the first level and an exit end located at the second level;
a series of equidistanced rigid reinforcing rings embracing the sleeve;
means for deploying the sleeve vertically from the first level to the second level;
an extendible axle member;
means for stretching the axle member from the first level to the second level in parallel to and distanced from the sleeve;
a series of elongated spacers, each fastened at one end thereof to one of the said rings and rotatably connected at its opposite end to the axle member; and
means for rotating one end of the sleeve relative to the other end about the axle member so that the sleeve becomes coiled around the axle member at a distance defined by the elongated spacers.

2. The system as claimed in claim 1 wherein the means for rotating the sleeve comprise a turntable coupled to an electric motor, the entrance of the sleeve being eccentrically mounted to the turntable.

3. The system as claimed in claim 2 wherein the extendible axle member is in the form of an axial cable connected to the center of the turntable.

4. The system as claimed in claim 3 wherein the means for deploying the sleeve comprise a base plate to which the exit end of the sleeve is connected, the base plate being supported by winch means for lowering and lifting the plate between the first and second levels.

5. The system as claimed in claim 4 wherein the winch means comprise at least two cables windable by electric motors.

6. The system as claimed in claim 5 wherein the axial cable is connected between the base plate and the center of the turntable.

7. The system as claimed in claim 1 wherein the said elongated spacers comprise cross-rods, opposite ends thereof being coupled to the axial cable intermediate swivel joints enabling a relative rotational movement between the two ends.

8. The system as claimed in claim 7 wherein retaining means are provided, annexed to the axial cable for retaining the cross-rods at a fixed distance one from the other.

9. The system as claimed in claim 8 wherein the retaining means comprise discs affixed to the axial cable.

10. The system as claimed in claim 1 wherein the rings are separate, discrete members.

11. The system as claimed in claim 1 wherein the rings are convolutions of a continuous coil.

12. The system as claimed in claim 9 wherein the coil is of springy steel wire.

13. The system as claimed in claim 1 wherein the means for deploying the sleeve comprise:
means supporting the sleeve at a location in the first level accessible by the individuals in need of evacuation;
a base plate;
a turntable coupled to rotating means for the rotation thereof, the exit end of the sleeve being eccentrically mounted to the turntable; and
winch means for lowering and lifting the base plate between the first and the second levels.

14. The system as claimed in claim 13 wherein the rotating means comprise an electric motor.

15. The system as claimed in claim 13 wherein the rotating means comprise manually operated means.

16. The system as claimed in claim 13 wherein the extendible axle member is in the form of an axial cable connected to the center of the turntable.

17. The system as claimed in claim 16 wherein the winch means comprise at least two cables windable by electric motors.

18. The system as claimed in claim 13 wherein the turntable is mounted to the base plate intermediate the rotating means.

19. The system as claimed in claim 18 wherein the sleeve supporting means comprise a plate with an opening for the entrance of said individuals.

20. The system as claimed in claim 13 wherein the said elongated spacers comprise cross-rods, opposite ends thereof being coupled to the axial cable intermediate swivel joints enabling a rotational movement between the two ends.

21. The system as claimed in claim 20 wherein retaining means are provided, annexed to the axial cable for retaining the cross-rods at a fixed distance one from the other.

22. The system as claimed in claim 21 wherein the retaining means comprise discs affixed to the axial cable.

23. The system as claimed in claim 13 wherein the rings are separate, discrete members.

24. The system as claimed in claim 13 wherein the rings are convolutions of a continuous coil.

25. The system as claimed in claim 24 wherein the coil is of springy steel wire.

26. A method of forming a coiled sleeve for the rescue by gliding therethrough of individuals from a first, elevated level to a second, lower level, comprising the steps of:
suspending the sleeve between a first support located at the first level and a second support located at the second level;
providing an extendible axle member between the first and the second supports, distanced from and parallel to the sleeve;
providing distancing means between the sleeve and the axle member; and
rotating one end of the sleeve relative to the other end thereof about the axle member.

27. The method as claimed in claim 26 wherein the distancing means comprise a plurality of elongated spacers connected at one end to the sleeve and at the other end to the axle member.

28. The method as claimed in claim 27 wherein the sleeve is made of cloth or the like material, reinforced by a plurality of equidistanced rigid rings, the elongated spacers are connected to at least some of the rings at fixed intervals therebetween.

29. The method as claimed in claim 28 wherein the first sleeve support is rotatable and the second sleeve support is capable of being lowered and lifted between the first and the second levels.

30. The method as claimed in claim 28 wherein the first sleeve support is stationary and the second sleeve support is rotatable and capable of being lowered and lifted between the first and the second levels.
